(19) United States
(12) Patent Application Publication
(10) Pub. No.: US 2024/0230986 A1
(43) Pub. Date: Jul. 11, 2024

(54) OPTICAL FIBER AND METHOD OF MANUFACTURING OPTICAL FIBER

(71) Applicant: FURUKAWA ELECTRIC CO., LTD., Tokyo (JP)

(72) Inventor: Kazunori MUKASA, Tokyo (JP)

(73) Assignee: FURUKAWA ELECTRIC CO., LTD., Tokyo (JP)

(21) Appl. No.: 18/613,402

(22) Filed: Mar. 22, 2024

Related U.S. Application Data
(63) Continuation of application No. PCT/JP2022/036532, filed on Sep. 29, 2022.

(30) Foreign Application Priority Data
Oct. 1, 2021 (JP) 2021-162887

(51) Int. Cl. G02B 6/02; C03B 37/012; C03B 37/014; C03B 37/027

(52) U.S. Cl. CPC G02B 6/02395; C03B 37/01211; C03B 37/014; C03B 37/027; C03B 2201/31; C03B 2201/50; C03B 2203/22

(57) ABSTRACT

An optical fiber includes: a core portion including a center core doped with germanium; and a cladding portion having a refractive index lower than a maximum refractive index of the core portion and surrounding an outer periphery of the core portion. The cladding portion has a relative refractive index difference of a positive value equal to or lower than 0.1% with respect to pure silica glass, an alkali metal element is doped in the center core to be diffused, and a peak of a concentration distribution of the alkali metal element in a radial direction is positioned at a distance away from the center of the center core by two times or more a radius of the center core.

This application is a continuation of International Application No. PCT/JP2022/036532, filed on Sep. 29, 2022 which claims the benefit of priority of the prior Japanese Patent Application No. 2021-162887, filed on Oct. 1, 2021, the entire contents of which are incorporated herein by reference.

### BACKGROUND

The present disclosure relates to an optical fiber and a method of manufacturing the same.

A technique of reducing a transmission loss at a wavelength of 1550 nm by doping an alkali metal element or an alkaline earth metal in a core region has been disclosed (for example, see JP-A-63-40744, JP-T-2007-504080, Japanese Patent No. 5489713, Japanese Patent No. 5974488 and JP-A-2015-105199). For example, in JP-T-2007-504080, an optical fiber codoped with germanium (Ge) and an alkali metal element in a core is proposed.

### SUMMARY

Germanium is the most widely used dopant for core regions of optical fibers, and it is also a material that has been handled for a long time. An optical fiber doped with germanium in the core region that has achieved a low transmission loss characteristic of 0.5 dB/km or less in a wide bandwidth including an OH loss has been reported at a product level. The OH loss is a transmission loss at a wavelength of the absorption peak of OH group, and the wavelength is approximately 1383 nm.

However, a method of further reducing transmission losses by additionally doping an alkali metal element while maintaining the low transmission loss characteristic in a wide bandwidth including an OH loss, which is an advantageous characteristic of the optical fiber doped with germanium in the core region, has not been proposed.

Three is a need for an optical fiber having a low transmission loss in a wide bandwidth and a method of manufacturing the same.

According to one aspect of the present disclosure, there is provided an optical fiber including: a core portion including a center core doped with germanium; and a cladding portion having a refractive index lower than a maximum refractive index of the core portion and surrounding an outer periphery of the core portion, wherein the cladding portion has a relative refractive index difference of a positive value equal to or lower than 0.1% with respect to pure silica glass, an alkali metal element is doped in the center core to be diffused, and a peak of a concentration distribution of the alkali metal element in a radial direction is positioned at a distance away from the center of the center core by two times or more a radius of the center core.

According to another aspect of the present disclosure, there is provided a method of manufacturing an optical fiber including: manufacturing a center core rod by synthesizing a portion corresponding to a center core and a portion corresponding to a range from a center of the portion corresponding to the center core to a position distant by more than two times a radius of the portion corresponding to the center core by a one-step synthesis process; arranging a glass pipe in which alkali metal element is doped on an inner surface, on an outer periphery of the center core rod; diffusing the alkali metal element to a portion corresponding to the center core; and drawing an optical fiber from an optical fiber preform including the center core rod and the glass pipe.

### BRIEF DESCRIPTION OF DRAWINGS

FIG. 1 is a schematic cross-section on a plane perpendicular to a longitudinal direction of an optical fiber according to an embodiment;

FIG. 2A is a schematic diagram of a refractive index profile of the optical fiber according to the embodiment;

FIG. 2B is a schematic diagram of a refractive index profile of the optical fiber according to the embodiment;

FIG. 2C is a schematic diagram of a refractive index profile of the optical fiber according to the embodiment;

FIG. 2D is a schematic diagram of a refractive index profile of the optical fiber according to the embodiment;

FIG. 3 is a diagram illustrating an example of a relationship between a radial direction position and a refractive index profile, and a K concentration;

FIG. 4 is a diagram illustrating an example of a relationship between a center-core radius ratio of an alkali-doping peak position and an OH loss, and a 1550 nm loss; and

FIG. 5 is a diagram illustrating an example of a relationship between a radius direction position and a K concentration, and a residual stress.

### DESCRIPTION OF EMBODIMENTS

Hereinafter, embodiments will be explained in detail with reference to the drawings. The embodiments explained below are not intended to limit the present disclosure. Moreover, in the respective drawings, identical reference symbols are assigned to identical or corresponding components. Moreover, in the present application, cut-off wavelength or effective cut-off wavelength refers to cable cut-off wavelength (λcc) defined by the International Telecommunication Union (ITU) in ITU-T G. 650.1. Moreover, for terms not specifically defined in the present specification, definitions and measurement methods in G.650.1 and G.650.2 apply.

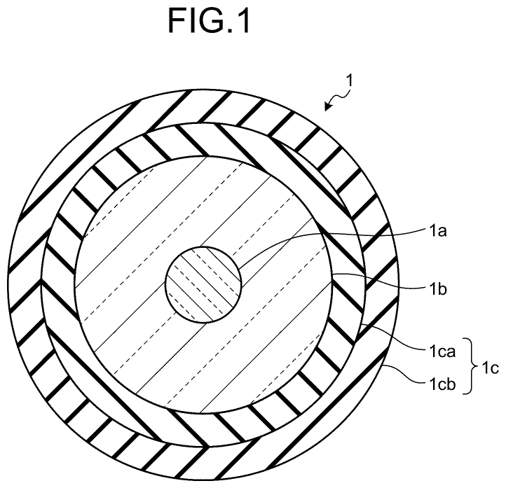

FIG. 1 is a schematic cross-section on a plane perpendicular to a longitudinal direction of an optical fiber according to an embodiment. An optical fiber 1 includes a core portion 1a and a cladding portion 1b that surrounds an outer periphery of the core portion 1a. Note that a portion that includes the core portion 1a and the cladding portion 1b in the optical fiber 1 is a portion made from glass in the optical fiber, and may be denoted as glass optical fiber. Moreover, the optical fiber 1 includes a coating layer 1c that surrounds an outer periphery of the cladding portion 1b. The coating layer 1c includes a primary layer 1ca that surrounds the outer periphery of the cladding portion 1b, and a secondary layer 1cb that surrounds an outer periphery of the primary layer 1ca. The optical fiber 1 including the coating layer 1c may be denoted as optical fiber core wire.

The primary layer 1ca and the secondary layer 1cb are made from resin. This resin is, for example, ultraviolet-curable resin. The ultraviolet-curable resin is a mixture of various kinds of resin materials, such as oligomer, diluent monomer, photopolymerization initiator, silane coupling agent, sensitizer, and lubricant, and an additive. As oligomer, known materials, such as polyether-based urethane acrylate, epoxy acrylate, polyester acrylate, and silicone acrylate may be used. As diluent monomer, known materials, such as monofunctional monomer and multifunctional monomer, may be used. Moreover, the additive is not limited to the ones described above, but a known additive and the like used for ultraviolet curable resin or the like may be widely used.

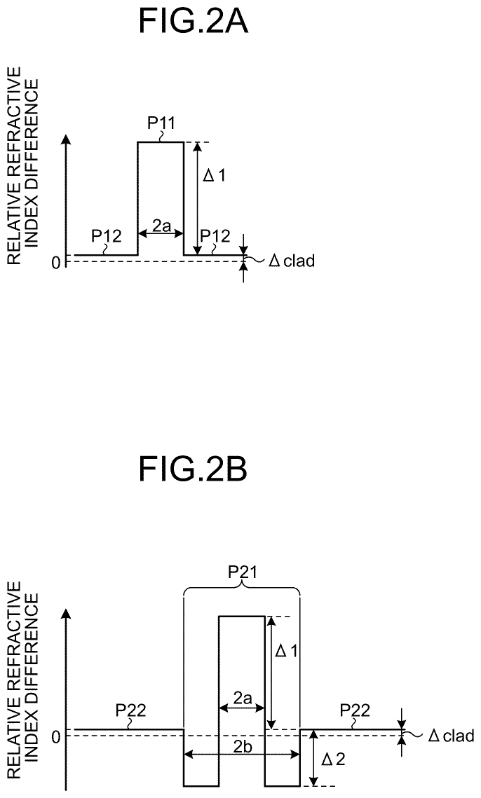

The optical fiber 1 has a refractive index profile, for example, as illustrated in FIG. 2A, 2B, 2C or 2D. FIGS. 2A, 2B, 2C, and 2D all show a refractive index profile in a radius direction from a center axis of the core portion 1a of the optical fiber 1. The refractive index profile is indicated by a relative refractive-index difference with respect to pure silica glass. Pure silica glass is silica glass with significantly high purity that includes substantially no dopants changing the refractive index, and the refractive index of which at a wavelength of 1550 nm is approximately 1.444.

FIG. 2A shows a step-index type refractive index profile. In FIG. 2A, a profile P11 indicates a refractive index profile of the core portion 1a, and a profile P12 indicates a refractive index profile of the cladding portion 1b. In the step-index type refractive index profile, a diameter (core diameter) of the core portion la is 2a, and a relative refractive-index difference of an average maximum refractive index (maximum relative refractive-index difference) of the core portion 1a with respect to an average refractive index of the cladding portion 1b is Δ1. Moreover, a relative refractive-index difference of an average refractive index of the cladding portion 1b with respect to the refractive index of pure silica glass is Δclad. In the case of FIG. 2A, a center core that is a portion at which the average refractive index is maximized in the core portion 1a corresponds to the entire core portion 1a. That is, the case of FIG. 2A is an example when the core portion is constituted of the center core.

FIG. 2B shows a so-called W-shaped type refractive index profile. In FIG. 2B, a profile P21 indicates a refractive index profile of the core portion la, and a profile P22 indicates a refractive index profile of the cladding portion 1b. In the W-shaped type refractive index profile, the core portion 1a is constituted of a center core having a diameter 2a, and a depressed layer that is formed to surround an outer periphery of the center core, that has a refractive index smaller than the refractive index of the cladding portion, and in which an inner diameter is 2a and an outer diameter is 2b. The center core is a portion in which the average refractive index is maximized in the core portion 1a. The maximum relative refractive-index difference of the center core with respect to the average refractive index of the cladding portion 1b is Δ1. The relative refractive-index difference of the average refractive index of the depressed layer with respect to the average refractive index of the cladding portion 1b is Δ2. Moreover, the refractive-index difference of the average refractive index of the cladding portion 1b with respect to the refractive index of pure silica glass is Δclad.

The case in FIG. 2B is an example when the core portion includes the center core and the depressed layer.

FIG. 2C shows a so-called trench type refractive index profile. In FIG. 2C, a profile P31 indicates a refractive index profile of the core portion 1a, and a profile P32 indicates a refractive index profile of the cladding portion 1b. In the trench type refractive index profile, the core portion 1a is constituted of a center core having a diameter 2a, an intermediate layer that is formed to surround an outer periphery of the center core, that has a refractive index smaller than the maximum refractive index of the center core, and in which an inner diameter is 2a and an outer diameter is 2b, and a trench layer that is formed to surround an outer periphery of the intermediate layer, and that has a refractive index smaller than the refractive index of the cladding portion, and in which an inner diameter is 2b and an outer diameter is 2c. The center core is a portion in which the average refractive index is maximized in the core portion 1a. The maximum relative refractive-index difference of the center core with respect to the average refractive index of the cladding portion 1b is Δ1. The relative refractive-index difference of the intermediate layer with respect to the average refractive index of the cladding portion 1b is Δ2. The relative refractive-index difference of the trench layer with respect to the average refractive index of the cladding portion 1b is Δ3. Moreover, the relative refractive-index difference of the average refractive index of the cladding portion 1b with respect to the refractive index of pure silica glass is Δclad. Note that Δ2 is normally set to the same value as 0% or its vicinity. The same value as 0% or its vicinity is, for example, a range between −0.05% to 0.05%. It has been observed that within the range of Δ2=−0.05% to 0.05%, there is no significant impact on the optical characteristics of the optical fiber.

The case in FIG. 2C is an example when the core portion includes the center core, the intermediate layer, and the trench layer.

FIG. 2D shows a so-called stepped refractive index profile. In FIG. 2D, a profile P41 indicates a refractive index profile of the core portion 1a, and a profile P42 indicates a refractive index profile of the cladding portion 1b. In the stepped refractive index profile, the core portion 1a is constituted of a center core having a diameter 2a, and a stepped layer that is formed to surround an outer periphery of the center core, that has a refractive index smaller than the refractive index of the center core and a larger than the refractive index of the cladding portion, and in which an inner diameter is 2a and an outer diameter is 2b. The center core is a portion in which the average refractive index is maximized in the core portion 1a. The average maximum relative refractive-index difference of the center core with respect to the average refractive index of the cladding portion 1b is Δ1. The relative refractive-index difference of the average refractive index of the stepped layer with respect to the average refractive index of the cladding portion 1b is Δ2. Moreover, the relative refractive-index difference of the average refractive index of the cladding portion 1b with respect to the refractive index of pure silica glass is Δclad.

The case in FIG. 2D is an example when the core portion includes the center core and the stepped layer.

The refractive index profile of the center core of the core portion 1a is not only a geometrically ideal shape of step index, but may also be a shape in which a shape of a top portion is not flat but has unevenness due to manufacturing characteristics, or in a sloping shape tapering downward from the top like a hem. In this case, the refractive index of a region that is substantially flat at the top portion of the refractive index profile within a range of the core diameter 2a of the core portion 1a based on the manufacturing design is to be an index to determine Δ1. Also in a case in which a substantially flat region seems to be separated into plural parts, or in a case in which the definition of substantially flat region is difficult because continuous changes occur, it has been confirmed that characteristics close to those desired may be achieved as long as at least either part of the core portion excluding portions in which the refractive index changes abruptly toward an adjacent layer is within the range of Δ1 described below, and a difference of Δ between the maximum value and the minimum value is within a value ±30%, and there are no particular problems.

Furthermore, the average refractive index of the depressed layer, the intermediate layer, the trench layer, the stepped layer, and the cladding portion 1b is an average value of the refractive index in the diameter direction of the refractive index profile. The cladding portion 1b has the refractive index lower than the maximum refractive index of the core portion 1a.

Next, constituent materials of the core portion 1a the cladding portion 1b of the optical fiber 1 will be explained. First, the cladding portion 1b is constituted of silica-based glass in which the relative refractive index difference takes a positive value of 0.1% or smaller by, for example, chlorine (Cl) with respect to pure silica glass. The cladding portion 1b does not require a dopant to change the refractive index other than Cl.

Next, the center core of the core portion is constituted of silica glass doped with Ge and an alkali metal element. The alkali metal element is, for example, potassium (K) and sodium (Na). An alkali metal element is a dopant that increase the refractive index and that reduce viscosity of silica glass. Note that the alkali metal element may be doped as a compound such as potassium compound and sodium compound. In the center core, Cl may be doped.

The stepped layer of the core portion 1a is constituted of silica glass doped with Ge and an alkali metal element. In the stepped layer, Cl may be doped. The depressed layer and the trench layer of the core portion 1a are constituted of silica glass that is doped with fluorine or boron, which is a refractive-index reducing dopant to reduce the refractive index. The intermediate layer is constituted of silica glass having components with refractive index same as or close to that of the cladding portion 1a. As the dopant to reduce the refractive index, it is more preferable to use fluorine in terms of manufacturability. Fluorine may be doped as fluorine compound. Moreover, in the depressed layer, the trench layer, and the intermediate layer, Cl may be doped.

Note that as long as the desired refractive index profile is achieved, an alkali metal element may be doped in layers other than the center core and the stepped layer, or in the cladding portion 1b.

Next, a concentration distribution of an alkali metal element in the optical fiber 1 will be specifically explained. In the optical fiber 1, an alkali metal element is doped such that it is diffused in the center core of the core portion 1a, and the peak of the concentration distribution in a radial direction of the alkali metal element is positioned at a distance away from the center of the center core by two times the radius of the center core. In the following, it will be explained assuming that the alkali metal element is potassium (K).

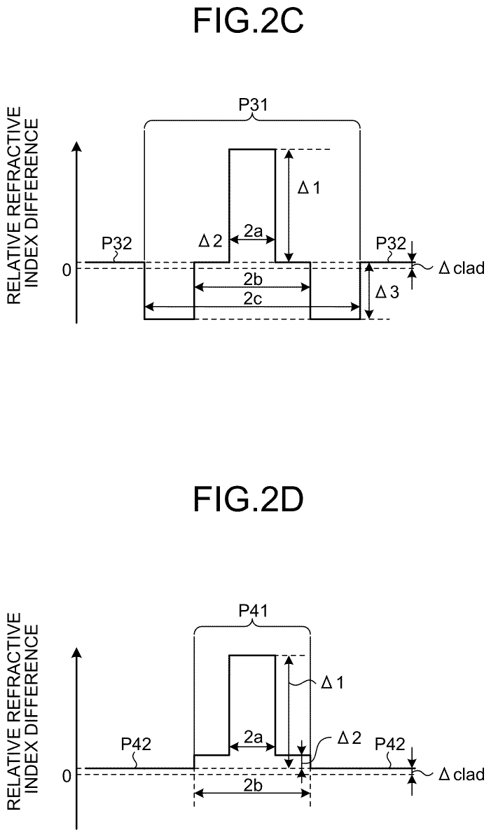

FIG. 3 is a diagram illustrating an example of a relationship between a radial direction position and a refractive index profile, and a K concentration. A zero position of the radial direction position is the center axis of the core portion 1a, and is the center axis of the center core. Moreover, a region in which the relative refractive index is large in the refractive index profile corresponds to the center core. As illustrated in FIG. 3, K is doped to be diffused in the center core, and the peak of the K concentration is positioned at a distance away from the center of the center core by two times the radius of the center core.

When manufacturing the optical fiber 1 as described, for example, first, a portion corresponding to the center core, and a portion corresponding to a range from the center of the portion corresponding to the center core to a position distant by more than two times the radius of the portion corresponding to the center core are synthesized through a one-step synthesis process, to manufacture a center core rod made from silica based glass. The one-step synthesis process includes a vapor-phase axial deposition (VAD) method and a modified chemical vapor deposition (MCVD).

Subsequently, a glass pipe doped with K, which is an alkali metal element, on an inner surface is arranged on an outer periphery of the center core rod, and the center core rod and the glass pipe are integrated by heat treatment. By the heat treatment for integration, or by the heat treatment and an additional treatment for integration, K is diffused to the portion corresponding to the center core. Thereafter, the optical fiber 1 is drawn from an optical fiber preform including the center core rod and the glass pipe.

According to the above manufacturing process, although there is a possibility of introducing an OH group onto a surface of the center core rod, the surface of the center core rod is positioned at a distance away from the center of the portion corresponding to the center core by two times the radius of the portion corresponding to the center core. Therefore, in the manufactured optical fiber 1 also, a position at which the OH group is present is at a distance from the center of the center core by more than two times the radius of the center core. Accordingly, because the OH group is distant from a region at which the optical intensity is high in the optical fiber 1, the OH loss is suppressed. Furthermore, because the center core is doped with K, the transmission loss at a wavelength of 1550 nm of the optical fiber 1 is also suppressed.

As explained above, the optical fiber 1 according to the first embodiment is an optical fiber with a low transmission loss in a wide bandwidth in which a transmission loss at a wavelength of 1550 nm and an OH loss are suppressed.

In the optical fiber 1, a transmission loss at a wavelength of 1550 nm is, for example, 0.185 dB/km or less. Moreover, an OH loss is, for example, 0.5 dB/km or less.

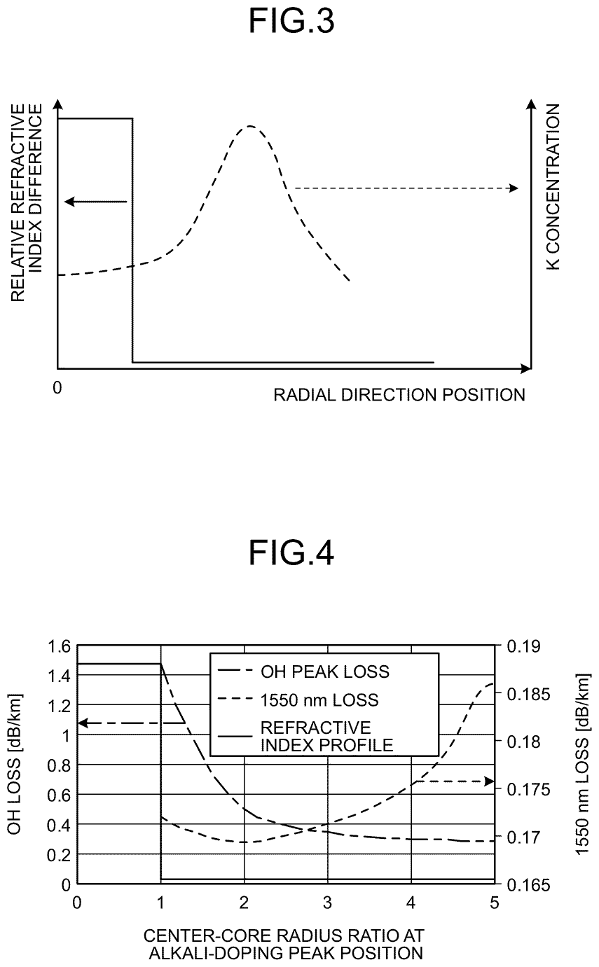

Subsequently, a relationship between a peak position of the K concentration and a transmission loss at a wavelength of 1550 nm, and an OH loss will be explained. FIG. 4 is a diagram illustrating an example of a relationship between a center-core radius ratio at an alkali-doping peak position and an OH loss, and a 1550 nm loss. The center-core radius ratio at an alkali-doping peak position (hereinafter, it may be denoted as center-core radius ratio simply) is a value obtained by standardizing a distance from the center of the center core to the position of the peak of the K concentration in a radial direction by the radius of the center core. Moreover, the 1550 nm loss represents a transmission loss at a wavelength of 1550 nm.

As illustrated in FIG. 4, when the center-core radius ratio is increased from 1, the OH loss (OH peak loss) decreases. However, when the center-core radius ratio is increased from 1, the 1550 nm loss once decreases but increases thereafter. This is considered because the structural relaxation promotion effect at the drawing by the alkali metal element decreases in a region in which the optical intensity is high in the optical fiber 1 if the center-core radius ratio is increased excessively from 1. Therefore, it is preferable that the center-core radius ratio be equal to or larger than 3 and equal to or smaller than 5, that is, the peak of a concentration distribution in the radial direction of the alkali metal element be positioned at a distance away from the center of the center core by three times or more and five times or less the radius of the center core, in terms of a balance between an effect of reducing the OH group and an effect of reducing the 1550 nm loss.

Next, the inventors have investigated changes in the average transmission loss at a wavelength of 1550 nm when Δ1 of the center core and the average concentration of K (average K concentration) at the center core are changed. The average concentration of K represents an average of concentration of K in the radial direction. The refractive index profile of a sample of an optical fiber used for the investigation is the step-index type, the W-shaped type, the stepped type, and the trench type. Moreover, the core diameter was adjusted such that (1) cable cut-off wavelength is to be 1200 nm, or (2) a cable cut-off wavelength is to be 1500 nm. The average transmission loss is an average transmission loss of samples prototyped under these various conditions.

As a result of the investigation, a strong correlation was observed between Δ1 and the average K concentration and the average transmission loss, while a strong correlation was not observed between the refractive index profile or the cable cut-off and the average transmission loss.

Tables 1-1 and 1-2 show the average transmission loss at a wavelength of 1550 nm when Δ1 and the average K concentration were changed. As shown in Tables 1-1 and 1-2, it is preferable that Δ1 be equal to or higher than 0.2% and equal to or lower than 0.6%, and that the average K concentration be equal to or lower than 100 ppm, to make the transmission loss at a wavelength of 1550 nm 0.185 dB/km or less. The reason for this is considered to be because increase of a transmission loss due to a bend loss is less likely to occur if Δ1 is equal to or higher than 0.2%, and an influence of the Rayleigh scattering loss caused by a dopant of the center core is small if Δ1 is equal to or lower than 0.6%.

TABLE 1-1
Unit: dB/km

| | Average K Concentration | | | | | |
|---|---|---|---|---|---|---|
| | 10 ppm | 20 ppm | 30 ppm | 40 ppm | 50 ppm | 60 ppm |
| Δ1 = 0.1% | 0.245 | 0.238 | 0.237 | 0.236 | 0.238 | 0.240 |
| Δ1 = 0.2% | 0.188 | 0.187 | 0.186 | 0.185 | 0.184 | 0.185 |
| Δ1 = 0.3% | 0.177 | 0.174 | 0.171 | 0.170 | 0.172 | 0.173 |
| Δ1 = 0.4% | 0.179 | 0.177 | 0.176 | 0.175 | 0.174 | 0.174 |
| Δ1 = 0.5% | 0.186 | 0.184 | 0.183 | 0.182 | 0.183 | 0.184 |
| Δ1 = 0.6% | 0.190 | 0.188 | 0.187 | 0.185 | 0.185 | 0.187 |
| Δ1 = 0.7% | 0.197 | 0.195 | 0.193 | 0.192 | 0.192 | 0.193 |

TABLE 1-2
Unit: dB/km

| Average K | 70 | 80 | 90 | 100 | 110 |
|---|---|---|---|---|---|
| Concentration | ppm | ppm | ppm | ppm | ppm |
| Δ1 = 0.1% | 0.242 | 0.247 | 0.257 | 0.269 | 0.281 |
| Δ1 = 0.2% | 0.186 | 0.188 | 0.192 | 0.198 | 0.208 |
| Δ1 = 0.3% | 0.176 | 0.178 | 0.181 | 0.185 | 0.194 |
| Δ1 = 0.4% | 0.175 | 0.177 | 0.183 | 0.186 | 0.197 |
| Δ1 = 0.5% | 0.186 | 0.188 | 0.191 | 0.194 | 0.205 |
| Δ1 = 0.6% | 0.189 | 0.191 | 0.195 | 0.199 | 0.211 |
| Δ1 = 0.7% | 0.195 | 0.198 | 0.201 | 0.204 | 0.214 |

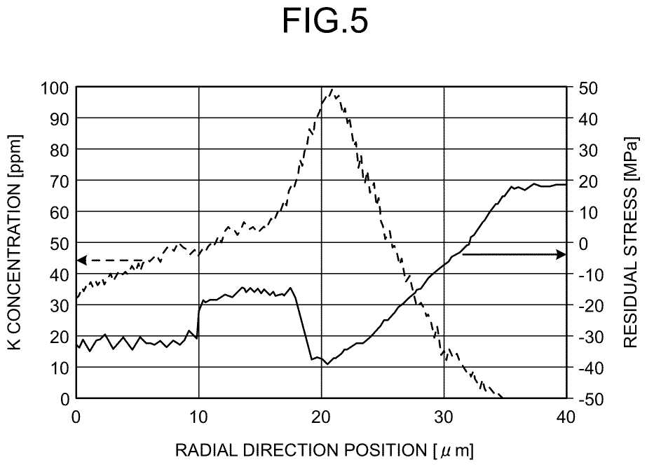

Next, a residual stress in the optical fiber 1 according to the embodiment will be explained. In the manufacturing process of the optical fiber 1, K diffuses from a doped position by thermal diffusion, and generates a residual compressive stress in a wide range including the center core. FIG. 5 is a diagram illustrating an example of a relationship between a radial direction position and the K concentration, and the residual stress in an optical fiber prototyped as an example of the optical fiber 1. A radius of the center core of the prototyped optical fiber is approximately 4 μm. As for the residual stress, a tensile stress is represented as positive value, and a compressive stress is represented as negative value.

In FIG. 5, the position of the peak of the K concentration corresponds to a position at which K is doped (position on a surface of the center core). That is, from FIG. 5, it is observed that the residual compressive stress exists in a wide range in the optical fiber, peaking at the position at which K is doped. This implies that structural relaxation in this region is progressing during the drawing, and it appears as an effect of reducing the transmission loss at a wavelength of 1550 nm.

As in FIG. 5, a state in which a peak of the minimum value of the residual stress is present on an outer periphery side relative to the center core in the radial direction is one example of a preferable state.

As an example, an optical fiber similar to the optical fiber according to the embodiment was manufactured by either of Method 1 and Method 2 below.

Method 1: First, by using a publicly known VAD apparatus, a core rod having a portion corresponding to a core portion of an optical fiber and a portion corresponding to a part of a cladding portion (one example of a center core rod) was manufactured through a one-step synthesis process. Subsequently, a tube corresponding to the rest of the cladding portion was prepared by a tube manufacturing method. A potassium chloride (KCl) material is heated in an electric furnace to a temperature above its melting point to be melted and vaporized, and then formed into aerosol particles by a cooling gas, and was transported into an inside of the tube using Ar carrier gas. Thus, potassium was deposited onto an inner surface. Thereafter, the core rod is inserted into the tube, a vacuum was established inside, and collapse treatment was performed by applying an oxyhydrogen flame to an outer portion of the tube, to thereby obtain an optical fiber preform. Subsequently, optical fibers were drawn from this optical fiber preform. Potassium is diffused in both directions to a center direction (center core direction) and outward in a diameter direction (cladding portion side) by respective heat treatment processes (particularly, the heat treatment in the collapse treatment) performed after deposition, and is doped in a desired region, such as the center core. Moreover, at the drawing, drawing conditions, such as drawing speed and drawing tension, were optimized to reduce the transmission loss.

Method 2: Similarly to Method 1, by using a publicly known VAD apparatus, a core rod having a portion corresponding to a core portion of an optical fiber and a portion corresponding to a part of a cladding portion was manufactured through a one-step synthesis process. Subsequently, aerosol particles generated by a method similar to Method 1 were flowed by using a VAD burner together with an oxyhydrogen gas, and potassium was deposited as uniformly as possible over an entire surface of the core rod. Thereafter, by using the VAD method or the jacketing method, a portion corresponding to the rest of the cladding was formed, to obtain an optical fiber preform. Subsequently, optical fibers were drawn from this optical fiber preform.

Tables 2-1 and 2-2 show design parameters and optical characteristics of optical fibers of manufactured samples Nos. 1 to 16. In Tables 2-1 and 2-2, “alkali-concentration peak position” represents a value obtained by standardizing a distance from the center of a center core to a position of a peak of K concentration in a radial direction by the radius of the center core. Moreover, “center-core alkali-concentration average value” is an average concentration of an alkali metal element in a center core. Furthermore, “Aeff” is an effective core area. Moreover, as for the refractive index profile, Nos. 1 to 5 are the step-index type, Nos. 6 to 10 are the W-shaped type, No. 11 is the stepped type, and Nos. 12 to 16 are the trench type.

TABLE 2-1

| | | | | Alkali | | | | | |
|---|---|---|---|---|---|---|---|---|---|
| | | | | Concen- | | | | | |
| | | | | tration | | | | OH | |
| | Δ1 | Δ2 | Δ3 | Peak | | | 2a | Loss | λcc |
| | [%] | [%] | [%] | Position | b/a | c/a | [μm] | [dB/km] | [nm] |
| No. 1 | 0.35 | | | 2.0 | | | 9.0 | 0.49 | 1202 |
| No. 2 | 0.40 | | | 2.2 | | | 8.5 | 0.46 | 1221 |
| No. 3 | 0.30 | | | 2.4 | | | 12.0 | 0.43 | 1486 |
| No. 4 | 0.60 | | | 2.6 | | | 8.0 | 0.40 | 1489 |
| No. 5 | 0.38 | | | 2.8 | | | 8.8 | 0.38 | 1225 |
| No. 6 | 0.38 | −0.03 | | 3.0 | 3.0 | | 8.6 | 0.36 | 1203 |
| No. 7 | 0.38 | −0.05 | | 3.2 | 3.2 | | 8.6 | 0.34 | 1192 |
| No. 8 | 0.36 | −0.40 | | 3.4 | 3.4 | | 8.5 | 0.36 | 1208 |
| No. 9 | 0.21 | −0.18 | | 3.6 | 3.6 | | 13.5 | 0.35 | 1496 |
| No. 10 | 0.28 | −0.12 | | 3.0 | 3.0 | | 13.0 | 0.38 | 1502 |
| No. 11 | 0.38 | 0.02 | | 3.6 | 3.6 | | 8.4 | 0.33 | 1220 |
| No. 12 | 0.38 | 0 | −0.12 | 5.0 | 2.8 | 5.0 | 8.1 | 0.28 | 1204 |
| No. 13 | 0.40 | 0 | −0.15 | 4.6 | 3.0 | 4.6 | 7.9 | 0.30 | 1215 |
| No. 14 | 0.27 | 0 | −0.17 | 4.0 | 2.5 | 4.0 | 11.8 | 0.32 | 1503 |
| No. 15 | 0.29 | 0 | −0.20 | 3.0 | 2.0 | 3.0 | 11.0 | 0.35 | 1377 |
| No. 16 | 0.36 | 0 | −0.60 | 4.0 | 3.0 | 4.0 | 8.0 | 0.37 | 1219 |

TABLE 2-2

| | Center-Core | | | | |
|---|---|---|---|---|---|
| | Alkali- | Transmission | | | |
| | Concentration | Loss | OH | | Aeff |
| | Average Value | @1550 nm | Loss | λcc | @1550 nm |
| | [ppm] | [dB/km] | [dB/km] | [nm] | [μm²] |
| No. 1 | 100 | 0.185 | 0.49 | 1202 | 83 |
| No. 2 | 90 | 0.182 | 0.46 | 1221 | 76 |
| No. 3 | 80 | 0.178 | 0.43 | 1486 | 117 |
| No. 4 | 50 | 0.185 | 0.40 | 1489 | 55 |
| No. 5 | 70 | 0.175 | 0.38 | 1225 | 77 |
| No. 6 | 60 | 0.174 | 0.36 | 1203 | 73 |
| No. 7 | 40 | 0.173 | 0.34 | 1192 | 72 |
| No. 8 | 35 | 0.177 | 0.36 | 1208 | 72 |
| No. 9 | 30 | 0.178 | 0.35 | 1496 | 122 |
| No. 10 | 25 | 0.173 | 0.38 | 1502 | 113 |
| No. 11 | 20 | 0.176 | 0.33 | 1220 | 78 |
| No. 12 | 15 | 0.184 | 0.28 | 1204 | 70 |
| No. 13 | 10 | 0.181 | 0.30 | 1215 | 71 |
| No. 14 | 5 | 0.178 | 0.32 | 1503 | 123 |
| No. 15 | 45 | 0.174 | 0.35 | 1377 | 102 |
| No. 16 | 55 | 0.177 | 0.37 | 1219 | 75 |

In all of the optical fibers Nos. 1 to 16, an transmission loss at a wavelength of 1550 nm and an OH loss were low. Moreover, it was possible to obtain various values for λcc and Aeff.

Particularly, in the optical fiber No. 7, Δ1 is 0.38%, Δ2 is −0.05%, the alkali-concentration peak position is 3.2, b/a is 3.2, 2a is 8.6 μm, and the center-core alkali-concentration average value is 40 ppm. Thus, characteristics in which the transmission loss is 0.173 dB/km, the OH loss is 0.34 dB/km, λcc is 1192 nm, and Aeff is 72 μm² are obtained, and favorable characteristics are achieved with Δ2 having a small absolute value, and is preferable.

Moreover, in No. 14, Δ1 is 0.27%, Δ2 is 0%, Δ3 is −0.17%, the alkali-concentration peak position is 4.0, b/a is 2.5, c/a is 4.0, 2a is 11.8 μm, and the center-core alkali-concentration average value is 5 ppm. Thus, characteristics in which the transmission loss is 0.178 dB/km, the OH loss is 0.32 dB/km, Δcc is 1503 nm, and Aeff is 123 μm² are obtained, and favorable characteristics are achieved while maintaining a large Aeff, and is preferable.

Furthermore, no particular issues arose even when these optical fibers were used in experiments of related technologies, such as cabling and connections.

Moreover, as a preferable example, 2a is equal to or larger than 7.9 μm and equal to or smaller than 13.5 μm, and Δ1 is equal to or larger than 0.21% and equal to or smaller than 0.60%.

Particularly, as a preferable example when the refractive index profile is the step-index type, 2a is equal to or larger than 8.0 μm and equal to or smaller than 12.0 μm, and Δ1 is equal to or larger than 0.30% and equal to or smaller than 0.60%. In the case of the step-index type, for example, the alkali-concentration peak position is equal to or larger than 2.0 and equal to or smaller than 2.8, and the center-core alkali-concentration average value is equal to or larger than 50 ppm and equal to or smaller than 100 ppm.

Moreover, as a preferable example when the refractive index profile is the W-shaped type, 2a is equal to or larger than 8.5 μm and equal to or smaller than 13.5 μm, Δ1 is equal to or larger than 0.21% and equal to or smaller than 0.38%, Δ2 is equal to or larger than −0.40% and equal to or smaller than −0.03%, and b/a is equal to or larger than 3.0 and equal to or smaller than 3.6. In the case of the W-shaped type, for example, the alkali-concentration peak position is equal to or larger than 3.0 and equal to or smaller than 3.6, and the center-core alkali-concentration average value is equal to or larger than 25 ppm and equal to or smaller than 60 ppm.

Furthermore, as a preferable example when the refractive index profile is the stepped type, 2a is 8.4 μm, Δ1 is 0.38%, Δ2 is 0.02%, and b/a is 3.6. In the case of the stepped type, for example, the alkali-concentration peak position is 3.6, and the center-core alkali-concentration average value is 20 ppm.

Moreover, as a preferable example when the refractive index profile is the trench type, 2a is equal to or larger than 7.9 μm and equal to or smaller than 11.8 μm, Δ1 is equal to or larger than 0.27% and equal to or smaller than 0.40%, Δ2 is equal to or larger than −0.05% and equal to or smaller than −0.05%, Δ3 is equal to or larger than −0.60% and equal to or smaller than −0.12%, b/a is equal to or larger than 2.0 and equal to or smaller than 3.0, and c/a is equal to or larger than 3.0 and equal to or smaller than 5.0. In the case of the trench type, for example, the alkali-concentration peak position is equal to or larger than 3.0 and equal to or smaller than 5.0, and the center-core alkali-concentration average value is equal to or larger than 5 ppm and equal to or smaller than 55 ppm.

The doping method of potassium is not limited to the methods described in the above examples. For example, at the time of manufacturing a core rod, silica soot may be first produced, and thereafter, provisional sintering may be performed at a temperature within a range not causing densification, and potassium may be doped by subjecting the provisionally sintered body to an immersion method. Moreover, instead of potassium chloride, potassium nitrite, iodide, bromide, and the like may be used. Furthermore, when doping with sodium instead of potassium, various kinds of sodium compounds may be used.

Moreover, the present disclosure is not limited to the embodiments described above. What is configured by appropriately combining the respective constituent elements described above is also included in the present disclosure. Moreover, more effects and modifications may be derived easily by those skilled in the art. Therefore, a wider aspect is not to be limited to the embodiments described above, and various alterations may be applied.

According to the present disclosure, an effect that an optical fiber with a low transmission loss in a wide bandwidth may be achieved is produced.

What is claimed is:

1. An optical fiber comprising:
a core portion including a center core doped with germanium; and
a cladding portion having a refractive index lower than a maximum refractive index of the core portion and surrounding an outer periphery of the core portion, wherein
the cladding portion has a relative refractive index difference of a positive value equal to or lower than 0.1% with respect to pure silica glass,
an alkali metal element is doped in the center core to be diffused, and
a peak of a concentration distribution of the alkali metal element in a radial direction is positioned at a distance away from the center of the center core by two times or more a radius of the center core.

2. The optical fiber according to claim 1, wherein the peak of the concentration distribution of the alkali metal element in the radial direction is positioned at a distance away from the center of the center core by three times or more and five times or less the radius of the center core.

3. The optical fiber according to claim 1, wherein the alkali metal element is potassium.

4. The optical fiber according to claim 1, wherein an average concentration of the alkali metal element in the center core is equal to or lower than 100 ppm.

5. The optical fiber according to claim 1, wherein a relative refractive index difference Δl of an average maximum refractive index of the center core with respect to an average refractive index of the cladding portion is equal to or larger than 0.2% and equal to or smaller than 0.6%.

6. The optical fiber according to claim 1, wherein a transmission loss at a wavelength of 1550 nm is 0.185 dB/km or less.

7. The optical fiber according to claim 1, wherein a transmission loss at a wavelength of an absorption peak of an OH group is 0.5 dB/km or less.

8. The optical fiber according to claim 1, wherein a peak of a minimum value of a residual stress is present on an outer periphery side relative to the center core in the radial direction.

9. The optical fiber according to claim 1, wherein
a diameter 2a of the center core is equal to or larger than 7.9 μm and equal to or smaller than 13.5 μm, and
an average maximum relative refractive index difference Δ1 of the center core with respect to an average refractive index is equal to or larger than 0.21% and equal to or smaller than 0.60%.

10. The optical fiber according to claim 9, wherein
the core portion includes the center core,
a diameter 2a of the center core is equal to or larger than 8.0 μm and equal to or smaller than 12.0 μm, and
an average maximum refractive index difference Δ1 of the center core with respect to an average refractive index of the cladding portion is equal to or larger than 0.30% and equal to or smaller than 0.60%.

11. The optical fiber according to claim 10, wherein
a peak of a concentration distribution of the alkali metal element in a radial direction is positioned at a distance away from a center of the center core by 2.0 times or more and 2.8 times or less the radius of the center core, and
an average concentration of the alkali metal element in the center core is equal to or higher than 50 ppm and equal to or lower than 100 ppm.

12. The optical fiber according to claim 9, wherein
the core portion includes the center core, and a depressed layer surrounding an outer periphery of the center core, the depressed layer having a refractive index smaller than the refractive index of the cladding portion, wherein
a diameter 2a of the center core is equal to or larger than 8.5 μm and equal to or smaller than 13.5 μm, and an average maximum relative refractive index difference Δ1 of the center core with respect to an average refractive index of the cladding portion is equal to or larger than 0.21% and equal to or smaller than 0.38%,
a relative refractive index difference Δ2 of an average refractive index of the depressed layer with respect to the average refractive index of the cladding portion is equal to or larger than −0.40% and equal to or smaller than −0.03%, and
a ratio (b/a) of an outer diameter 2b of the depressed layer to the 2a is equal to or larger than 3.0 and equal to or smaller than 3.6.

13. The optical fiber according to claim 12, wherein
the peak of the concentration distribution of the alkali metal element in the radial direction is positioned at a distance away from the center of the center core by 3.0 times or more and 3.6 times or less the radius of the center core, and
an average concentration of the alkali metal element in the center core is equal to or higher than 25 ppm and equal to or lower than 60 ppm.

14. The optical fiber according to claim 9, wherein
the core portion includes the center core, and a stepped layer surrounding an outer periphery of the center core, the stepped layer having a refractive index smaller than the refractive index of the center core and larger than the refractive index of the cladding portion,
a diameter 2a of the center core is 8.4 μm, and an average maximum refractive index difference Δ1 of the center core with respect to the average refractive index of the cladding portion is 0.38%,
a relative refractive index difference of an average refractive index Δ2 of the stepped layer with respect to the average refractive index of the cladding portion is 0.02%, and
a ratio (b/a) of an outer diameter 2b of the stepped layer to the 2a is 3.6.

15. The optical fiber according to claim 14, wherein
the peak of the concentration distribution of the alkali metal element in the radial direction is positioned at a distance away from the center of the center core by 3.6 times the radius of the center core, and
an average concentration of the alkali metal element in the center core is 20 ppm.

16. The optical fiber according to claim 9, wherein
the core portion includes the center core, and an intermediate layer surrounding an outer periphery of the center core, the intermediate layer having a refractive index smaller than a maximum refractive index of the center core, and a trench layer surrounding an outer periphery of the intermediate layer, the trench layer having a refractive index smaller than the refractive index of the cladding portion, wherein
a diameter 2a of the center core is equal to or larger than 7.9 μm and equal to or smaller than 11.8 μm, and an average maximum relative refractive index difference Δ1 of the center core with respect to an average refractive index of the cladding portion is equal to or larger than 0.27% and equal to or smaller than 0.40%,
a relative refractive index difference Δ2 of the intermediate layer with respect to the average refractive index of the cladding portion is equal to or larger than −0.05% and equal to or smaller than 0.05%,
a relative refractive index difference Δ3 of the trench layer with respect to the average refractive index of the cladding portion is equal to or larger than −0.60% and equal to or smaller than −0.12%,
a ratio (b/a) of an outer diameter 2b of the intermediate layer to the 2a is equal to or larger than 2.0 and equal to or smaller than 3.0, and
a ratio (c/a) of an outer diameter 2c of the trench layer to the 2a is equal to or larger than 3.0 and equal to or smaller than 5.0.

17. The optical fiber according to claim 16, wherein
the peak of the concentration distribution of the alkali metal element in the radial direction is positioned at a distance away from the center of the center core by 3.0 times or more and 5.0 times or less the radius of the center core, and
an average concentration of the alkali metal element in the center core is equal to or higher than 5 ppm and equal to or lower than 55 ppm.

18. A method of manufacturing an optical fiber comprising:
manufacturing a center core rod by synthesizing a portion corresponding to a center core and a portion corresponding to a range from a center of the portion corresponding to the center core to a position distant by more than two times a radius of the portion corresponding to the center core by a one-step synthesis process;
arranging a glass pipe in which alkali metal element is doped on an inner surface, on an outer periphery of the center core rod;
diffusing the alkali metal element to a portion corresponding to the center core; and
drawing an optical fiber from an optical fiber preform including the center core rod and the glass pipe.

19. The method of manufacturing an optical fiber according to claim 18, wherein the one-step synthesis process is a vapor-phase axial deposition (VAD) method.
